(19) United States
(12) Patent Application Publication
(10) Pub. No.: US 2002/0065893 A1
(43) Pub. Date: May 30, 2002

(54) Method and apparatus for inviting guests to an event

(76) Inventor: Mark T. McCormack, Omaha, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 09/725,838

(22) Filed: Nov. 29, 2000

(51) Int. Cl. G06F 15/16

(52) U.S. Cl. 709/206

(57) ABSTRACT

A method and apparatus for inviting individuals to events comprising audio and visual data that is stored and distributed on electronic storage media. The data comprises a basic invitation and additional desired information, including the time and date of the event as well as directions to the event location. Once completed, the invitation is enclosed in a mail-safe case and delivered to the prospective guests. The invitation is operable on a CD player, which translates the data into audible information for the guest. The invitation is also operable on a guest-operated interface, which can be used to view photo and/or graphic art images included by the event host. In a further embodiment of the method and apparatus, an RSVP prompt is provided along with the invitation data. The guest uses the guest-operated interface to transmit the guest's response to the host via the Internet or some other network connection.

### BACKGROUND OF THE INVENTION

1. Field of the Invention

The present invention relates to the field of invitations. More particularly, the invention relates to a method and apparatus for inviting guests to social and business events using electronic audio-visual means that provides the guests with the invitation and additional necessary information concerning the event.

2. Description of the Related Art

Invitations to weddings, graduations, parties and other events are ubiquitous in today's society. These invitations are traditionally prepared in a pre-printed or handwritten form and mailed to their intended recipients. The invitations usually contain basic information such as a description of the event, when the event will be held and where it will be held. Other information included in standard paper invitations may include a map to the event's location, gift registration lists and an RSVP form.

Individuals holding the social event are limited by the paper medium in that their invitations cannot typically include musical score, personal voice messages from the host or photos that may either be too large or numerous to conveniently mail on a large scale. When desired, the host may ask the guest to RSVP his or her attendance at the social event. With paper invitations, this is usually handled by phone or by including an RSVP mailer that the guest completes and returns to the host. Receiving phone confirmations and a plurality of tiny RSVP cards can be difficult to keep organized and may prove to be unreliable. What is needed is a novel method and means for inviting guests to a social event, using versatile, inexpensive and reliable technology.

Compact disc players and CD-ROM computer drives can be found in most households. In fact most automobiles produced today come with compact disc players as standard equipment. Such equipment is used for a wide range of purposes, from playing music or games stored on the discs to saving files and pictures. Storing information and miscellaneous files on compact discs and other storage media provide the advantages of increased reliability, storability and transferability while reducing storage space and cost. Volumes of paper files, photographs and sound bites can all be conveniently stored on a single compact disc for simple retrieval, time and time again. Another distinct advantage that electronic storage media provide is that the files and photographs stored on the media are easily shared by any number of individuals using the Internet and other network connections to transfer the data from one computer to another.

Therefore, there is a need for an improved method and apparatus for inviting individuals to social and business functions, using electronic storage media, such as compact discs, that can provide the guests with their invitations and additional desired information relating to the event.

### SUMMARY OF THE INVENTION

The present method and apparatus comprises an invitation to a social event that contains text, audio and/or graphical data related to the social business event. The invitation data includes basic information such as a description of the event, when the event will be held and where it will be held. The host may prepare photographs, graphic art, maps or itemized information, such as gift registration, hotel information, addresses and phone numbers. Once prepared by the host, the invitation data is stored on a plurality of compact discs or other electronic storage media.

The host may decide to prepare the invitation to include audio information only. In this case, the prepared information is read by the host, or other chosen individual, and recorded onto a compact disc such that it can later be played on CD players or the CD-ROM drives of personal computers. If the host so desires, musical score befitting of the event can be set as the background to the voice recording. The recorded information is divided into separate tracks and labeled accordingly. For example, track one may be a greeting by the host, track two may contain the invitation itself, track three may contain directions to the event location and a fourth track may contain information regarding local accommodations. The tracks run seamlessly, but can be individually selected and replayed by the invitee without the necessity of listening to the entire disc.

The host may also decide to include additional data, such as photographs, maps or graphic art. The data is simply recorded to the electronic storage media as additional data after the voice tracks. This allows the electronic storage media, in the case of a compact disc, to still be utilized by a CD player for the voice-recorded portions. The additional data is easily viewed using a CD-ROM drive on the guest's personal computer. If the guest desires, the information can be printed using an attached printer or shared with additional people using the Internet or other network connection.

Once the invitations are prepared, they are enclosed in individual cases of the type typically used for mailing such electronic storage media. The host then mails the invitations directly to his or her guests. Once received, the guest simply inserts the disk into a CD player or the CD-ROM drive of a personal computer and listens to or views the invitation data. After viewing the invitation data, the guest can open the RSVP on a personal computer and respond accordingly. The guest's RSVP response is forwarded to the host via the Internet or some other network connection.

Thus, a primary objective of the invention is to provide an improved method and apparatus for inviting guests to social and business events.

Another objective of the invention is to provide an improved method of inviting guests to a social or business event using text, audio and/or video data stored on electronic storage media.

Another objective of the invention is to provide an improved apparatus that can receive specific invitation information and data and then be mailed to intended guests of a social or business event.

Another objective of the invention is to provide an improved method and apparatus for inviting guests to social and business events that is further capable of delivering electronically stored pictures, graphic art, music and other desired information.

Another objective of the invention is to provide an improved method and apparatus that allows invitees of a social event to electronically RSVP via the Internet or other network connection.

These and other objectives will be apparent to those skilled in the art.

### BRIEF DESCRIPTION OF THE DRAWINGS

FIG. 1 is a flow chart depicting the method of the present invention; and

FIG. 2 is a flow chart depicting another embodiment of the method of the present invention.

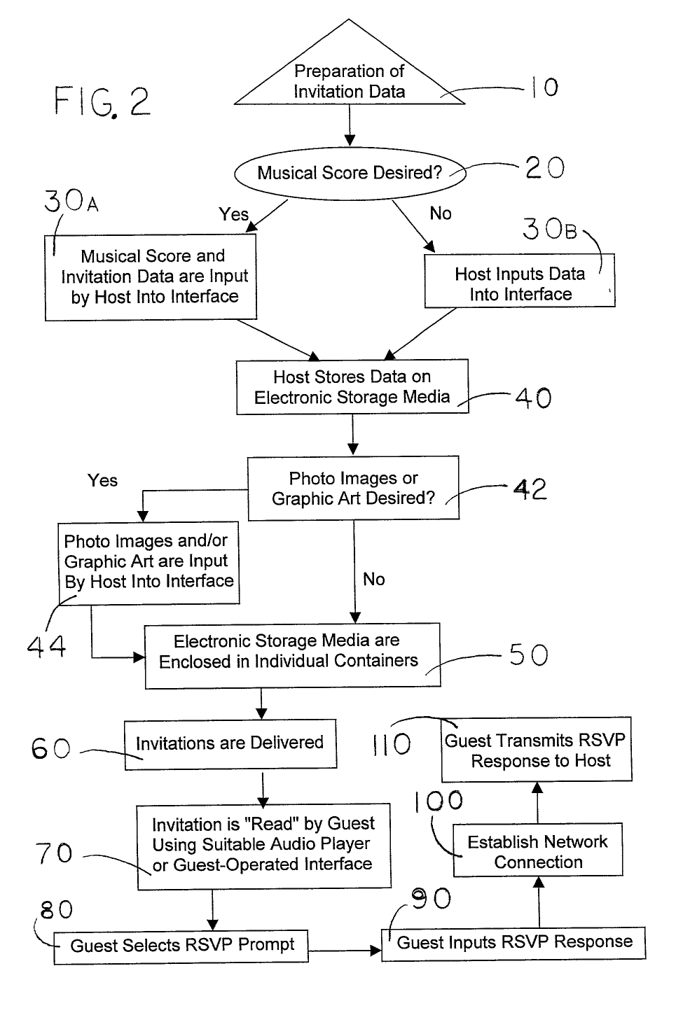

### DESCRIPTION OF THE PREFERRED EMBODIMENT

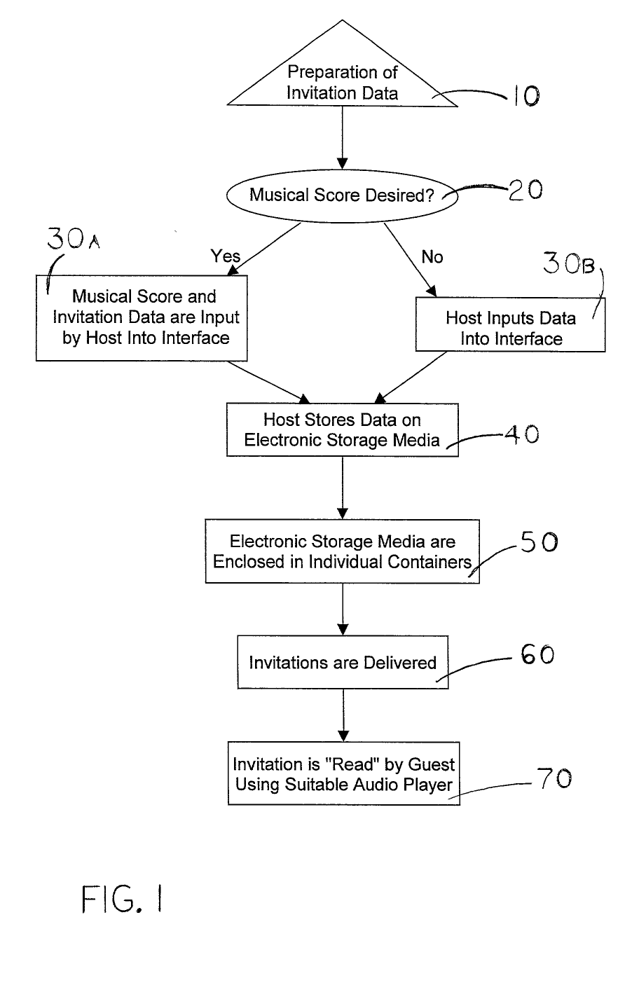

A method of inviting guests to an event is shown in FIG. 1, provided with an electronic storage medium and a host-operated interface having at least an input device and a drive capable of reading and storing information onto electronic storage media. In the preferred embodiment of the present method, the electronic storage medium is a compact disc and the drive is a CD-ROM drive, capable of “burning” compact discs. However, it is contemplated that other storage media such as mini-discs, DVD discs, floppy discs and Zip discs, and drives typically associated therewith, could be implemented in the present method.

The host of the event initiates the present method by preparing and determining the substance of the general invitation and its accompanying data (step 10). The host then inputs the desired invitation data into the host-operated interface (step 20). Although the invitation data can comprise any desired information, it will typically include at least information that provides the intended guests with a description of the event, the date and time when the event will be held and the location of where it will be held. It is contemplated that the present method could be used for most types of events including, but not limited to, weddings, birthday parties, dinner functions, graduation parties and business conferences. Once the invitation data is input, it is stored onto the electronic storage medium (step 40). To make the invitation data easier to use by a guest, the invitation data is divided into separate selectable tracks or segments when it is stored onto the medium. For example, the first track may include a greeting by the host, the second track may contain the invitation, the third track may contain directions to the event location and the fourth track may contain information regarding local accommodations. The tracks run seamlessly, but can be individually selected and replayed by the guest without the necessity of listening to the entire disc.

Should the host desire, the invitation could be comprised of audio information only. In this case, the host will prepare the desired invitation information and read the same into the host-operated interface. It is anticipated that any individual, such as a professional voice-over artist, could read the invitation information into the interface. If the host so desires, musical score befitting of the specific event can be set as the background to the voice recording (step 30a). The musical score can either be recorded simultaneously with the reading of the invitation information (step 40), or mixed with the voice recording in a later step.

When the subject invitation is prepared by the host to be read using a guest-operated interface, the host may include additional invitation data, such as photographs, video clips, maps or graphic art (step 42). Such data is simply recorded to the electronic storage media as additional information after the audio tracks (step 44). The additional data is easily viewed on the display device of the guest-operated interface, using a CD-ROM drive (step 70). This additional information can also be printed by the guest using a printer attached to the guest-operated interface or shared with additional people using the Internet or other network connection.

Once the invitations are prepared, the host simply encloses each disc into individual cases (step 50) that are suitable for safely mailing the discs to their intended recipients. The host then delivers the invitations to the intended guests (step 60). Once the guests receive the invitation, the guest simply inserts the disk into a CD player or the CD-ROM drive of a guest-operated interface and listens to or views the invitation data (step 70). After listening to or viewing the invitation data, the guest can select an RSVP prompt (step 80) provided on the display of the guest-operated interface, and respond accordingly by inputting his or her response into the guest-operated interface (step 90). The guest then establishes a network connection between the guest-operated interface and the host-operated interface (step 100). The guest is then able to transmit his or her RSVP response from his or her guest-operated interface to the host-operated interface via the Internet or network connection (step 110).

In the drawings and in the specification, there has been set forth preferred embodiments of the invention and although specific items are employed, these are used in a generic and descriptive sense only and not for purposes of limitation. Changes in the form and proportion of parts, as well as in the substitution of equivalents, are contemplated as circumstances may suggest or render expedient without departing from the spirit or scope of the invention as further defined in the following claims.

Thus it can be seen that the invention accomplishes at least all of its stated objectives.

I claim:

1. A method of inviting guests to an event provided with an electronic storage medium and a host-operated interface having at least an input device and a drive capable of reading and storing information onto electronic storage media, comprising the steps of:
inputting invitation data, comprising an invitation to the event, into said interface; and
storing said invitation data onto said electronic storage medium.

2. The method of claim 1 wherein said electronic storage medium is a compact disc.

3. The method of claim 2 further comprising the step of dividing said invitation data into separate selectable segments.

4. The method of claim 1 further comprising the step of incorporating music with said invitation data.

5. The method of claim 1 further comprising the step of incorporating photo images or graphic art with said invitation data.

6. The method of claim 1 further comprising the step of inserting said electronic storage medium into an electronic storage medium container suitable for mailing electronic storage media.

7. The method of claim 6 further comprising the step of delivering said container and electronic storage medium to the guests.

8. The method of claim 7 further provided with a guest-operated interface having at least an input device, a display device, a processor, a drive capable of reading data from electronic storage media and a network for operatively connecting said host-operated interface to said guest-operated interface.

9. The method of claim 8 further comprising the step of inserting the electronic storage medium in said drive.

10. The method of claim 9 further comprising the step of displaying said invitation data on said display device.

11. The method of claim 10 further comprising the step of displaying an RSVP prompt on said display device.

12. The method of claim 11 further comprising the step of inputting a guest response to said RSVP prompt.

13. The method of claim 12 further comprising the step of establishing a network connection between said guest-operated interface and said host-operated interface.

14. The method of claim 13 further comprising the step of transmitting said guest response from said guest-operated interface to said host-operated interface via said network connection.

15. The method of claim 7 further provided with a guest-operated CD player capable of reading and processing data stored on a compact disc.

16. The method of claim 15 further comprising the step of inserting said compact disc into said CD player and processing said invitation data into an audible invitation.

17. An apparatus for inviting guests to an event, comprising:
an electronic storage medium capable of storing data; and
electronic data comprising an invitation to the event;
said electronic data being stored on said electronic storage medium.

18. The apparatus of claim 17 wherein said electronic storage medium is a compact disc.

19. The apparatus of claim 18 wherein said electronic data is stored on said electronic storage medium and divided into separate selectable segments.

20. The apparatus of claim 19 wherein said electronic data is further comprised of photo images or graphic art.

21. The apparatus of claim 19 wherein said electronic data is further comprised of music.

22. The apparatus of claim 19, further comprising:
a host-operated interface having at least an input device and a drive capable of reading and storing information onto electronic storage media; and
a guest-operated interface having at least an input device, a display device, a processor and a drive capable of reading data from electronic storage media.

23. The apparatus of claim 22 wherein said invitation data is operative on said processor for displaying said invitation data on said display.

24. The apparatus of claim 23 wherein said invitation data is further operative on said processor for displaying an RSVP prompt on said display.

25. The apparatus of claim 24 wherein said invitation data is further operative on said processor for receiving RSVP input from the guest.

26. The apparatus of claim 25 further comprising a network for operatively connecting said host-operated interface to said guest-operated interface.

27. The apparatus of claim 26 wherein said invitation data is operative on said processor for transmitting said RSVP input from said guest-operated interface to said host-operated interface via said network connection.

28. The apparatus of claim 19 in combination with a guest-operated CD player capable of reading and processing data stored on a compact disc, wherein said invitation data is operative on said CD player for converting said invitation data into an audible invitation.
